(19) United States
(12) Patent Application Publication
(10) Pub. No.: US 2007/0136202 A1
(43) Pub. Date: Jun. 14, 2007

(54) Personal-information managing apparatus, method of providing personal information, computer product, and personal-information-providing system

(75) Inventors: Yasuhiro Noma, Kawasaki (JP); Akira Shinozawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/391,237

(22) Filed: Mar. 29, 2006

(30) Foreign Application Priority Data
Dec. 13, 2005 (JP) 2005-359473

(51) Int. Cl. G06Q 99/00

(52) U.S. Cl. 705/51

(57) ABSTRACT

An access-permission-information issuing unit issues access permission information for accessing personal information on a user, in response to a request from a personal terminal of the user. A personal-information notifying unit notifies a destination terminal of the personal information corresponding to the access permission information, under conditions that the destination terminal that received the access permission information from the personal terminal presents the access permission information.

### BACKGROUND OF THE INVENTION

1. Field of the Invention

The present invention relates to a technology for providing electronic personal information with enhanced convenience of confirming a user while preventing a leakage of the personal information.

2. Description of the Related Art

Recently, digital authentication systems that combine an identification (ID) code for identifying a person and authentication information (such as a code number and biometrics information using fingerprint and vein) for certifying that the ID code is used by the identified person is widely used.

While such digital authentication systems are being spread, certificates such as a driver's license, an insurance card, and a passport are usually issued as a paper medium by government authorities. A printing technique of hologram and a rewrite preventing seal is used for the paper certificates, and these certificates are obligatorily updated every constant period to prevent falsification of the certificates.

However, it is troublesome to always carry the paper certificate for an identification of an individual. There is also a possibility of occurrence of an error in visual confirmation of the certificate when a third person tries to identify the person holding the certificate. Therefore, there are various proposals of techniques for increasing convenience of the certificate by computerization or digitalization of the certificate.

For example, Japanese Patent Application Laid-Open No. 2002-207838 discloses a technique of transmitting an electronic certificate (such as a driver's license and an insurance card, which are hereinafter referred to as an “electronic certificate”) to a user's portable terminal. Japanese Patent Application Laid-Open No. 2002-366675 discloses a technique of transmitting an electronic certificate to a user-confirmation terminal based on a transmission request sent from a user's terminal.

However, according to the technique disclosed in the former literature, if the portable terminal having received the electronic certificate is lost, a malicious third person who obtains this portable terminal can misuse the electronic certificate.

It is considered to directly transmit the electronic certificate to the user-confirmation terminal instead of the user's portable terminal by using the technique disclosed in the latter literature. However, according to this technique, since the electronic certificate is delivered to a third person without passing through the user of the certificate, there is a possibility of a personal information leakage. Therefore, this technique is unpopular among general users.

Therefore, it is very important to realize a personal-information providing method that can increase convenience of confirming a user while preventing leakage of the personal information.

### SUMMARY OF THE INVENTION

It is an object of the present invention to at least solve the problems in the conventional technology.

A personal-information managing apparatus according to one aspect of the present invention includes an access-permission-information issuing unit that issues access permission information for accessing personal information on a user, in response to a request from a personal terminal of the user; and a personal-information notifying unit that notifies a destination terminal of the personal information corresponding to the access permission information, under conditions that the destination terminal that received the access permission information from the personal terminal presents the access permission information.

A method according to another aspect of the present invention is for providing personal information using a personal-information managing apparatus that manages electronic personal information. The method includes issuing including the personal-information managing apparatus issuing access permission information for accessing personal information on a user, in response to a request from a personal terminal of the user; and notifying including the personal-information managing apparatus notifying a destination terminal of the personal information corresponding to the access permission information, under conditions that the destination terminal that received the access permission information from the personal terminal presents the access permission information.

A computer-readable recording medium according to still another aspect of the present invention stores a computer program for a personal-information managing apparatus that manages electronic personal information. The computer program causes a computer to execute issuing access permission information for accessing personal information on a user, in response to a request from a personal terminal of the user; and notifying a destination terminal of the personal information corresponding to the access permission information, under conditions that the destination terminal that received the access permission information from the personal terminal presents the access permission information.

A personal-information-providing system according to still another aspect of the present invention includes a personal-information managing apparatus that manages electronic personal information; a personal terminal that is used by a user; and a destination terminal that is a disclosure destination of the personal information. The personal-information managing apparatus includes an access-permission-information issuing unit that issues access permission information for accessing personal information on a user, in response to a request from a personal terminal of the user; and a personal-information notifying unit that notifies a destination terminal of the personal information corresponding to the access permission information, under conditions that the destination terminal that received the access permission information from the personal terminal presents the access permission information. The personal terminal includes an access-permission-information delivering unit that delivers the access permission information issued by the personal-information managing apparatus to the destination terminal. The destination terminal includes an access-permission-information presenting unit that presents the access permission information delivered from the personal terminal to the personal-information managing apparatus.

A method according to still another aspect of the present invention is for providing personal information using a personal-information managing apparatus that manages electronic personal information, a personal terminal that is used by a user, and a destination terminal that is a disclosure destination of the personal information. The method includes issuing including the personal-information managing apparatus issuing access permission information for accessing personal information on a user, in response to a request from the personal terminal of the user; delivering including the personal terminal delivering the access permission information issued by the personal-information managing apparatus to the destination terminal; presenting including the destination terminal presenting the access permission information delivered from the personal terminal to the personal-information managing apparatus; and notifying including the personal-information managing apparatus notifying the destination terminal of the personal information corresponding to the access permission information under conditions that the destination terminal presented the access permission information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating a personal-information providing method according an embodiment of the present invention;

FIG. 2 is a block diagram of a personal-information managing apparatus according to the present embodiment;

FIG. 3 is a flowchart of a processing procedure for a process performed by a personal-information-providing system;

FIG. 4 is a flowchart of a processing procedure for a process when a quick-response (QR) code includes an effective period;

FIG. 5 is a flowchart of a processing procedure for a process when the QR code does not include the effective period;

FIG. 6 is a flowchart of a processing procedure for a process when a change of the effective period is permitted;

FIG. 7 is a schematic for illustrating an authentication of a personal terminal;

FIG. 8 is a schematic for illustrating an authentication of a destination terminal;

FIG. 9 is a block diagram of a personal-information managing apparatus having an authentication function;

FIG. 10 is a schematic for illustrating an example of personal authentication information and destination authentication information;

FIG. 11 is a schematic for illustrating an example of the destination authentication information in accordance with personal information items;

FIG. 12 is a block diagram of the destination terminal according to the present embodiment;

FIG. 13 is a schematic for illustrating a personal-information-reference notifying process;

FIG. 14 is a schematic for illustrating a personal-information updating process and a personal-information-update notifying process;

FIG. 15 is a block diagram of a personal-information managing apparatus having a personal-information updating function and a personal-information notifying function;

FIG. 16 is a schematic for illustrating a charging process;

FIG. 17 is a schematic for illustrating a charge-information updating process; and

FIG. 18 is a block diagram of a personal-information managing apparatus having a record function and a charge function.

### DETAILED DESCRIPTION OF THE PREFERRED EMBODIMENTS

Exemplary embodiments of the present invention are explained below in detail with reference to the accompanying drawings.

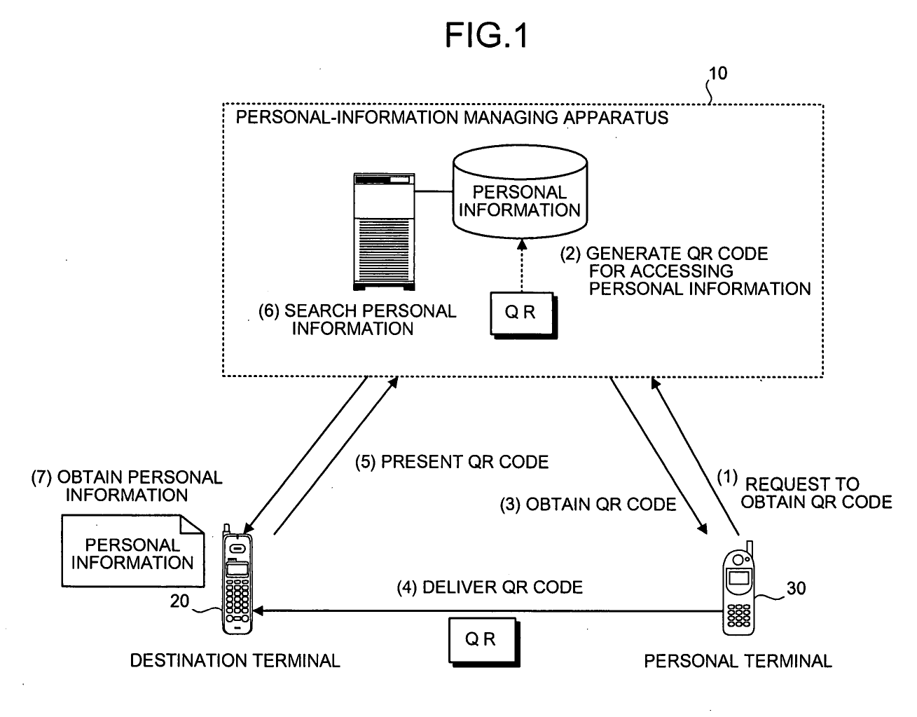

FIG. 1 is a schematic for illustrating a personal-information providing method according an embodiment of the present invention. In the personal-information providing method according to the present invention, personal information is provided by mutually exchanging data between a personal-information managing apparatus 10, a destination terminal 20, and a personal terminal 30. Commercially available portable telephones and personal digital assistant (PDA) terminals can be used for the destination terminal 20 and the personal terminal 30.

In the personal-information providing method according to the present invention, the personal-information managing apparatus 10 issues access permission information (such as a QR code) for permitting access to personal information, in response to a request from the personal terminal 30. The personal terminal 30 delivers the obtained QR code to the destination terminal 20. The destination terminal 20 presents the QR code to the personal-information managing apparatus 10, thereby obtaining the personal information corresponding to the QR code.

Specifically, when the personal terminal 30 transmits a QR code obtaining request to the personal-information managing apparatus 10 (see (1) in FIG. 1), the personal-information managing apparatus 10 having received this request generates a QR code for accessing corresponding personal information (see (2) in FIG. 1), and transmits the QR code to the personal terminal 30. Thus, the personal terminal 30 obtains the transmitted QR code (see (3) in FIG. 1).

The personal terminal 30 delivers the QR code to the destination terminal 20 which is a destination of the personal information (see (4) in FIG. 1). The QR code is delivered to the destination terminal 20 when a user of the personal terminal 30 operates the personal terminal 30 to make the destination terminal 20, installed in a shop register or the like, read the QR code (or transmit the QR code to the destination terminal 20), to identify the own self.

When the destination terminal 20 presents the QR code to the personal-information managing apparatus 10 (see (5) in FIG. 1), the personal-information managing apparatus 10 searches the personal information corresponding to the presented QR code (see (6) in FIG. 1), and transmits the personal information to the destination terminal 20. Thus, the destination terminal 20 obtains the personal information (see (7) in FIG. 1).

The personal terminal 30 receives only the QR code that indicates the personal information instead of receiving the personal information. Therefore, the personal terminal 30 does not hold the personal information. A terminal that can obtain the personal information based on the presentation of the QR code is limited to the destination terminal 20. Therefore, even when the personal terminal 30 is lost, the personal information is not leaked out.

The personal-information providing method according to the present invention includes the operation of delivering the QR code from the personal terminal 30 to the destination terminal 20. Therefore, the personal information is provided via the user of the personal terminal 30. In other words, the user's confirmation is necessary to provide the personal information. Consequently, it is possible to prevent an unaware transmission of the personal information to an unknown third person.

According to the present embodiment, the use of the QR code that indicates personal information as access permission information is explained. Alternatively, a uniform resource locator (URL), a file identifier, and a data identifier can be also used to indicate the personal information.

In generating the QR code (see (2) in FIG. 1), the personal-information managing apparatus 10 can extract corresponding personal information from a personal information database (DB), copy the extracted personal information to a predetermined temporary area, and generate the QR code which indicates the copy of the personal information. With this arrangement, an illegal use of the personal information such as tampering can be prevented effectively.

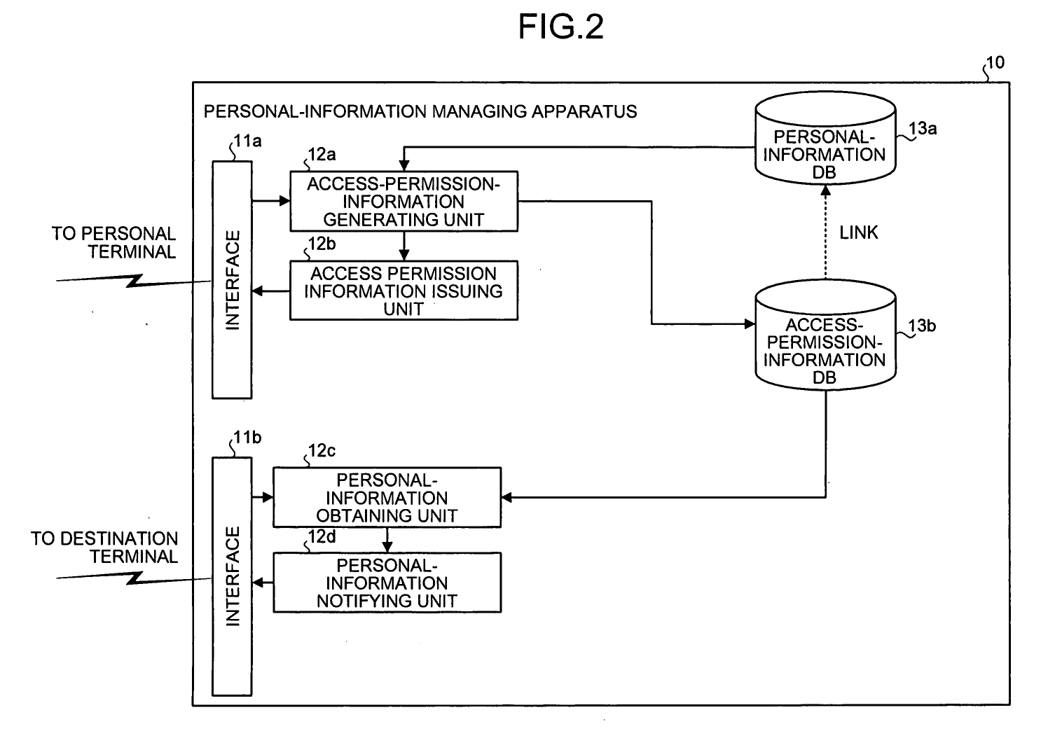

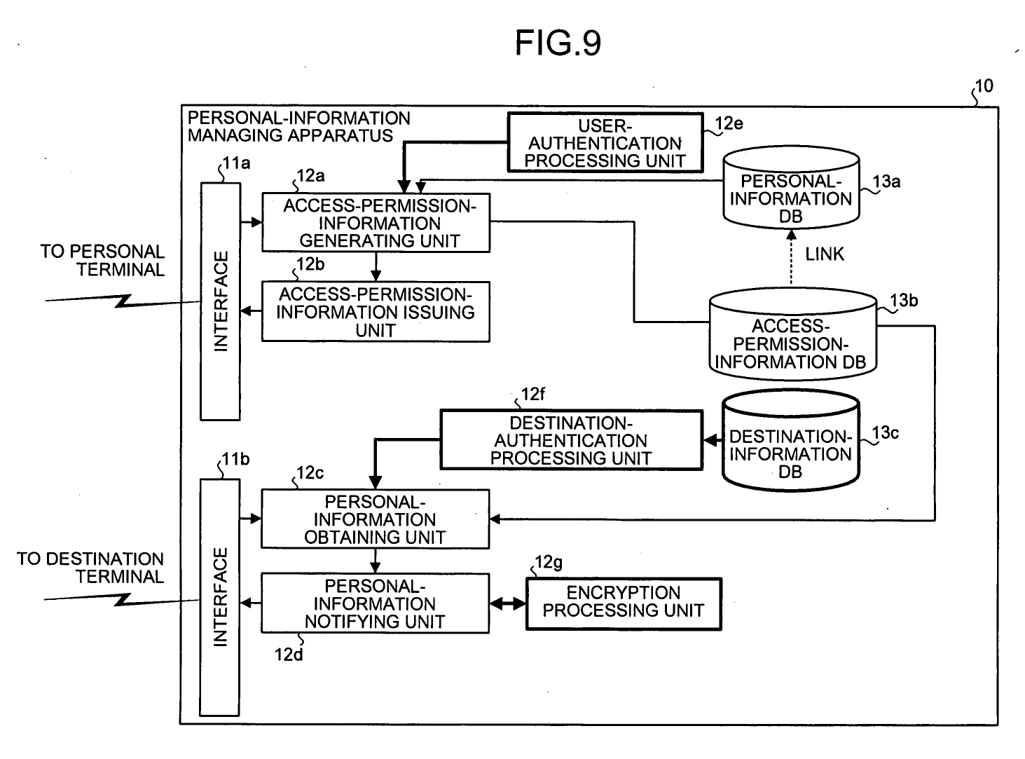

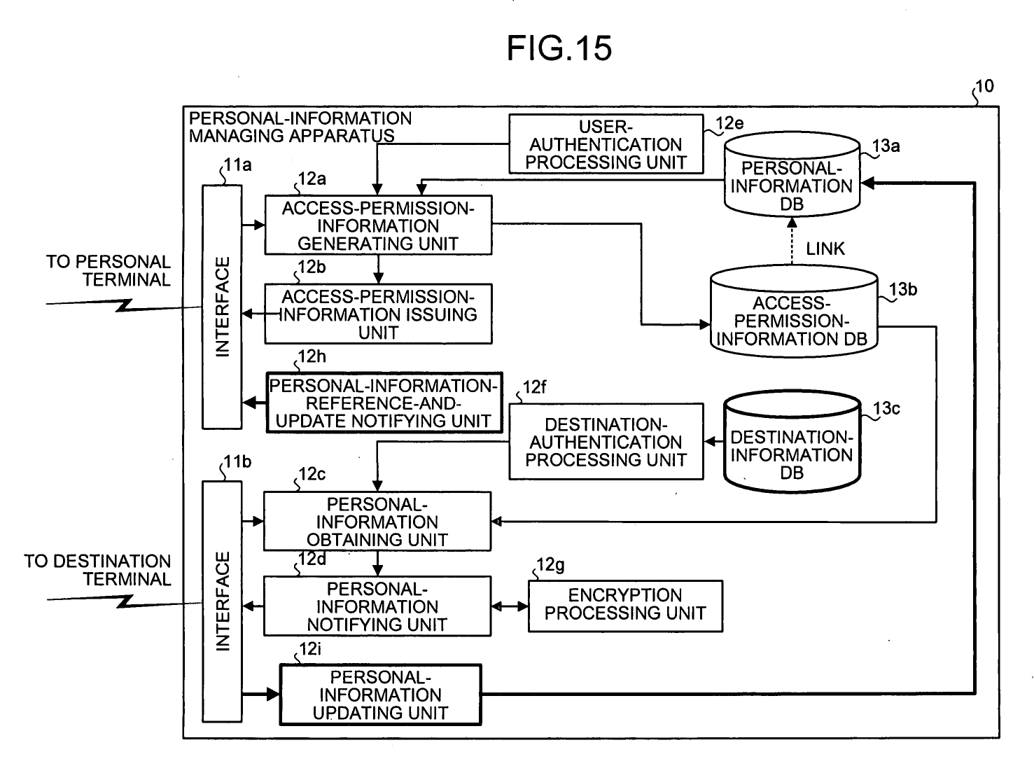

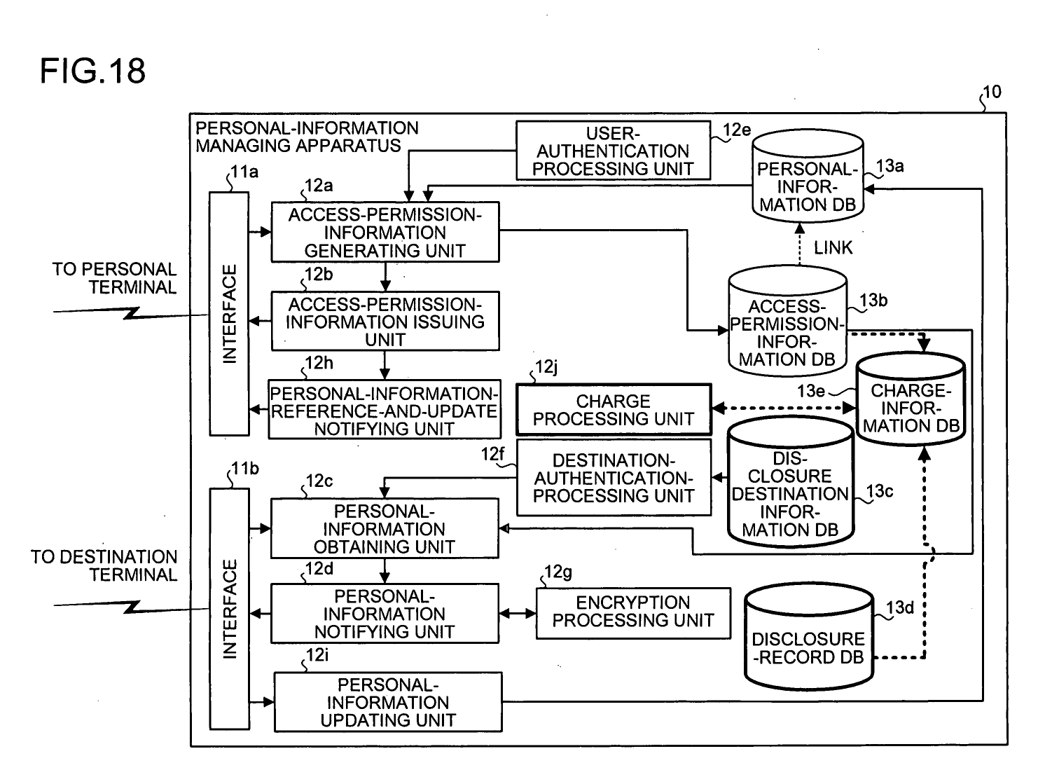

FIG. 2 is a block diagram of the personal-information managing apparatus 10 according to the present embodiment. The block diagram in FIG. 2 depicts a minimum configuration of the personal-information managing apparatus 10. Configurations of the personal-information managing apparatus 10 shown in FIG. 2 added with other constituent elements are explained later with reference to FIG. 9, FIG. 15, and FIG. 18.

The personal-information managing apparatus 10 includes an interface 11a, an interface 11b, an access-permission-information generating unit 12a, an access-permission-information issuing unit 12b, a personal-information obtaining unit 12c, a personal-information notifying unit 12d, a personal-information DB 13a, and an access-permission-information DB 13b.

The interface 11a is configured by a communication device that exchanges data with the personal terminal 30. The interface 11a is a processor that receives a request of obtaining access permission information, from the personal terminal 30, delivers the obtaining request to the access-permission-information generating unit 12a, and transmits the access permission information received from the access-permission-information issuing unit 12b to the personal terminal 30. The interface 11a can be configured by a radio device or a wired device.

The interface 11b is configured by a communication device that exchanges data with the destination terminal 20. The interface 11b is a processor that receives presentation of the access permission information from the destination terminal 20, delivers the access permission information to the personal-information obtaining unit 12c, and transmits the personal information received from the personal-information notifying unit 12d to the destination terminal 20. The interface 11b can be configured by a radio device or a wired device similarly to the interface 11a. While the interface 11a is separated from the interface 11b in this embodiment, the interfaces 11a and 11b can be configured as one processor.

The access-permission-information generating unit 12a is a processor that receives an access permission information obtaining request from the personal terminal 30 via the interface 11a, and extracts personal information corresponding to the obtaining request from the personal-information DB 13a. The access-permission-information generating unit 12a also generates access permission information indicating the extracted personal information, delivers the access permission information to the access-permission-information issuing unit 12b, and stores the access permission information in the access-permission-information DB 13b.

The access-permission-information generating unit 12a generates a QR code that indicates corresponding personal information, as the access permission information. A URL, a file identifier, and a data identifier can be also generated, instead of the QR code.

The access-permission-information issuing unit 12b is a processor that issues the access permission information (QR code) generated by the access-permission-information generating unit 12a, to the personal terminal 30 via the interface 11a.

The personal-information obtaining unit 12c is a processor that receives the access permission information (QR code) from the destination terminal 20 via the interface 11b, and obtains personal information corresponding to the access permission information by searching the access-permission-information DB 13b. Specifically, the personal-information obtaining unit 12c extracts information that coincides with the access permission information presented by the destination terminal 20, from the access-permission-information DB 13b, and obtains personal information indicated by the extracted access permission information from the personal-information DB 13a. The personal-information obtaining unit 12c delivers the obtained personal information to the personal-information notifying unit 12d.

The personal-information notifying unit 12d is a processor that notifies the personal information received from the personal-information obtaining unit 12c, to the destination terminal 20 via the interface 11b.

The personal-information DB 13a stores electronic certificates of a driver's license, an insurance card, a passport, and the like. The personal information stored in the personal-information DB 13a is information having various kinds of information such as name and address related to an identifier such as an ID code that uniquely identifies each person.

The access-permission-information DB 13b stores the access permission information (such as a QR code) generated by the access-permission-information generating unit 12a, together with a date of generating the access permission information and an effective period of the access permission information. While the access-permission-information DB 13b is configured separately from the personal-information DB 13a in this embodiment, the personal-information DB 13a can be also configured to store same information as that stored in the access-permission-information DB 13b.

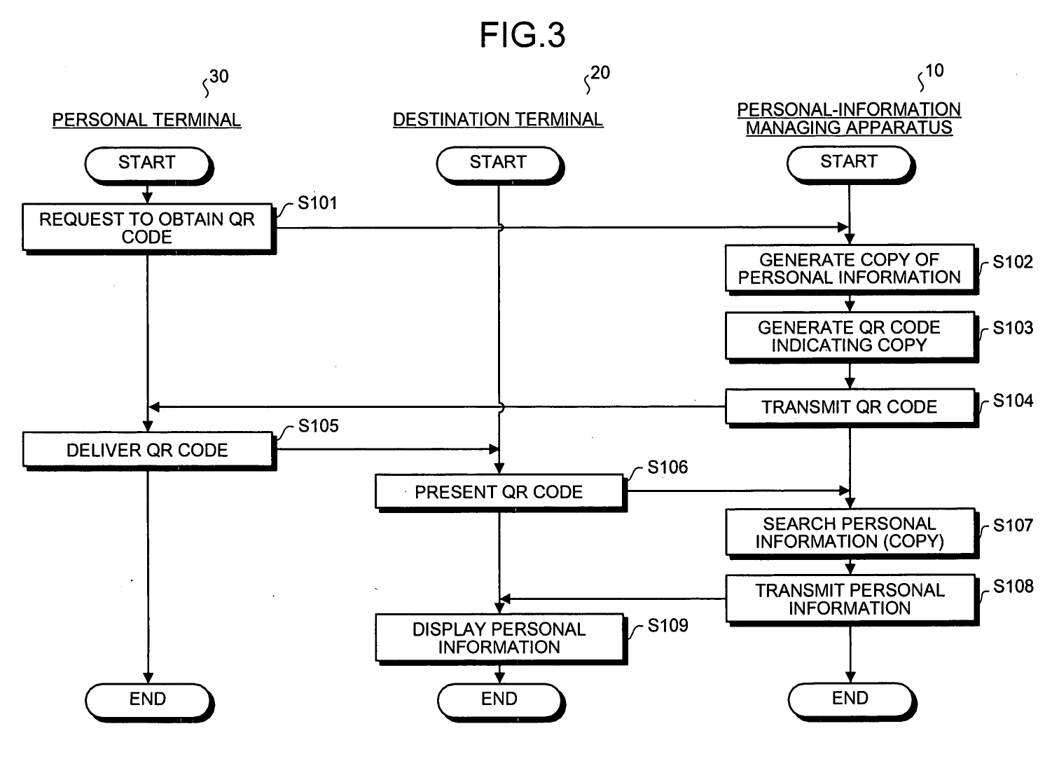

FIG. 3 is a flowchart of a processing procedure for a process performed by the personal-information-providing system. In the following explanation, a “QR code” is used as the “access permission information”.

When the personal terminal 30 transmits a request for obtaining a QR code to the personal-information managing apparatus 10 (step S101), the personal-information managing apparatus 10 having received this obtaining request extracts corresponding personal information from the personal-information DB 13a, and copies the extracted personal information (step S102). The personal-information managing apparatus 10 generates a QR code indicating this copy (step S103), and transmits the generated QR code to the personal terminal 30 (step S104).

The user of the personal terminal 30 operates the personal terminal 30 to make the destination terminal 20 read the QR code, thereby delivering the QR code to the destination terminal 20 (step S105). The destination terminal 20 having received the QR code presents this QR code to the personal-information managing apparatus 10 (step S106). The personal-information managing apparatus 10 presented with the QR code searches personal information (searches the copy) corresponding to the QR code (step S107), and transmits the extracted personal information to the destination terminal 20 (step S108). The destination terminal 20 receives the personal information, and display units the personal information (step S109).

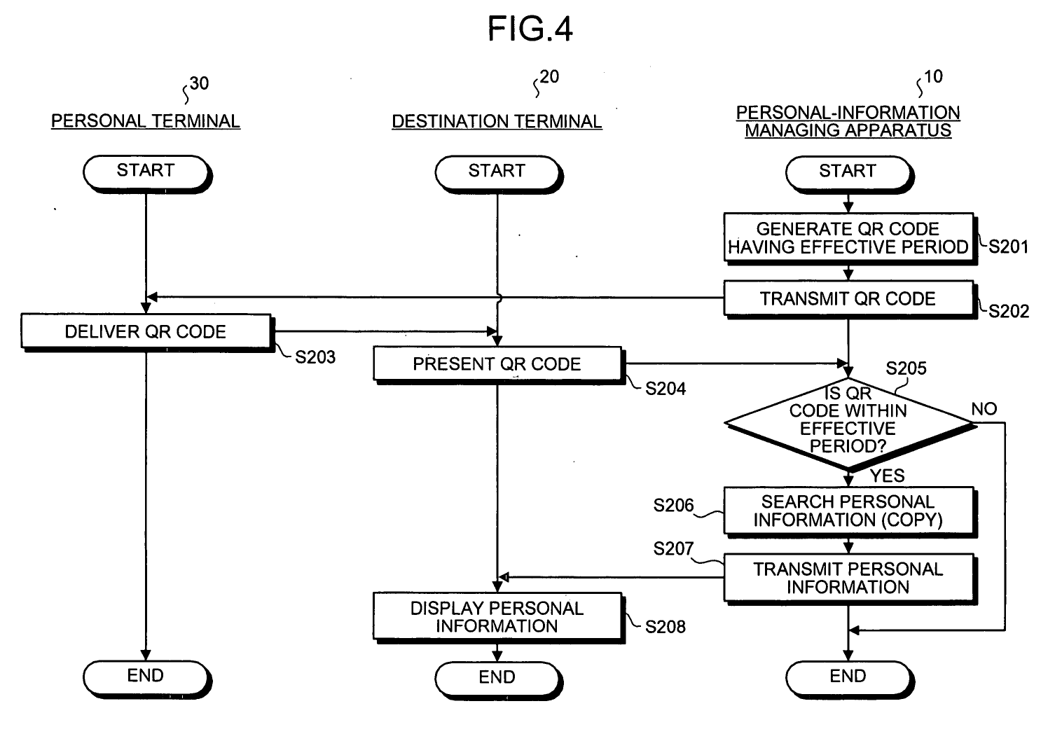

While the process flow of providing personal information via a QR code is explained above with reference to FIG. 3, the QR code can be set with an effective period so that personal information can be provided during only this effective period of the QR code. A process flow when the QR code has an effective period is explained below with reference to FIG. 4.

FIG. 4 is a flowchart of a processing procedure for a process when a quick-response (QR) code includes an effective period. A process procedure corresponding to step S103 shown in FIG. 3 is expressed as step S201 in FIG. 4, and subsequent process procedure is shown in FIG. 4. Process procedures corresponding to steps S101 and S102 shown in FIG. 3 are omitted from FIG. 4.

When receiving a QR code obtaining request from the personal terminal 30, the personal-information managing apparatus 10 generates a QR code with an effective period (step S201), and transmits the generated QR code to the personal terminal 30 (step S202). The user of the personal terminal 30 operates the personal terminal 30 to make the destination terminal 20 read the QR code, thereby delivering the QR code to the destination terminal 20 (step S203). The destination terminal 20 receives the QR code, and presents or transmits the QR code to the personal-information managing apparatus 10 (step S204).

The personal-information managing apparatus 10 presented with the QR code compares the effective period included in the QR code with the current time, and determines whether the current time is within the effective period of the QR code (step S205). When the current time is within the effective period (step S205: Yes), the personal-information managing apparatus 10 searches personal information (searches the copy) corresponding to the QR code (step S206), and transmits the extracted personal information to the destination terminal 20 (step S207). The destination terminal 20 receives the personal information, and display units the personal information (step S208). When it is determined that the current time has passed the effective period at step S205 (step S205: No), the process after step S206 is not carried out.

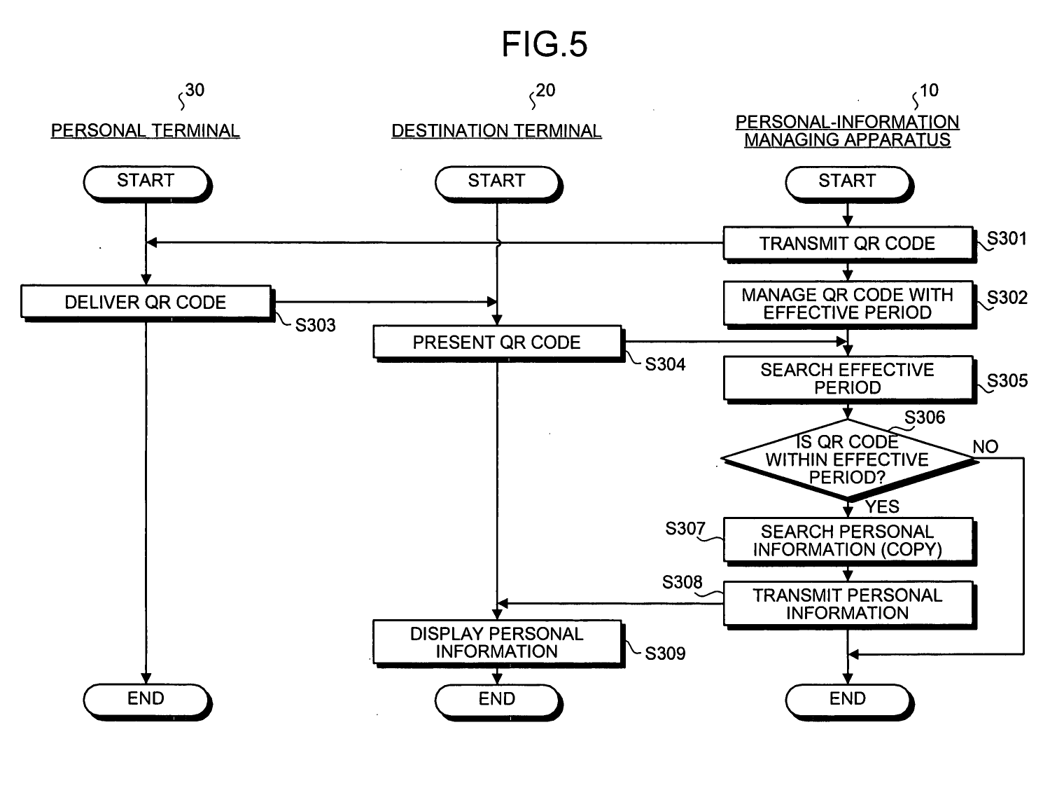

While the effective period management using the QR code having an effective period is explained above with reference to FIG. 4, the effective period can be also managed without including an effective period in the QR code. The effective period management without including an effective period in the QR code is explained below with reference to FIG. 5.

FIG. 5 is a flowchart of a processing procedure for a process when the QR code does not include the effective period. The QR code indicates a “QR code that does not include an effective period”. A process procedure corresponding to step S202 in FIG. 4 is expressed as step S301 in FIG. 5, and subsequent process procedure is shown in FIG. 5.

The personal-information managing apparatus 10 transmits a generated QR code (that does not include an effective period) to the personal terminal 30 (step S301). At the same time, the personal-information managing apparatus 10 manages the QR code by relating it to the effective period, in the access-permission-information DB 13b (step S302). The user of the personal terminal 30 operates the personal terminal 30 to make the destination terminal 20 read the QR code, thereby delivering the QR code to the destination terminal 20 (step S303). The destination terminal 20 receives the QR code, and presents or transmits the QR code to the personal-information managing apparatus 10 (step S304).

The personal-information managing apparatus 10 presented with the QR code searches the access-permission-information DB 13b for the effective period corresponding to the QR code (step S305). The personal-information managing apparatus 10 compares the extracted effective period with the current time to determine whether the current time is within the effective period (step S306). When it is determined that the current time is within the effective period (step S306: Yes), the personal-information managing apparatus 10 searches personal information (searches the copy) corresponding to the QR code (step S307), and transmits the extracted personal information to the destination terminal 20 (step S308).

The destination terminal 20 having received the personal information display units the personal information (step S309). When it is determined at step S306 that the current time has passed the effective period (step S306: No), the process after step S307 is not carried out.

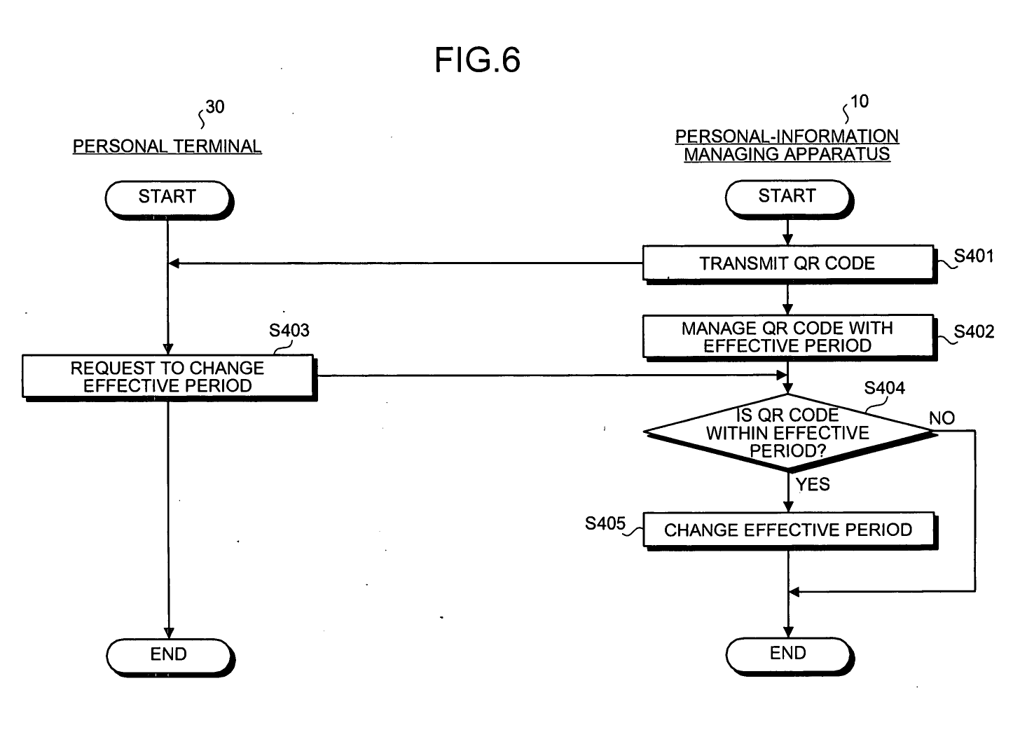

While an example of setting in advance the effective period during which personal information can be accessed is explained with reference to the flowcharts shown in FIG. 4 and FIG. 5 respectively, it is also possible to configure the personal-information managing apparatus such that the device can change the effective period. An example of permitting a change of the effective period is explained next with reference to FIG. 6. FIG. 6 is a flowchart of a processing procedure for a process when a change of the effective period is permitted.

The personal-information managing apparatus 10 transmits a QR code to the personal terminal 30 (step S401), and manages the QR code by relating it to the effective period, in the access-permission-information DB 13b (step S402). The user of the personal terminal 30 wanting to change the effective period operates the personal terminal 30 to transmit an effective period change request to the personal-information managing apparatus 10 (step S403). It is also possible to instantly terminate the effective period based on the effective period change request.

The personal-information managing apparatus 10 having received the effective period change request refers to the access-permission-information DB 13b, thereby determining whether the current time is within the effective period of the QR code (step S404). When the current time is within the effective period (step S404: Yes), the personal-information managing apparatus 10 changes the effective period (step S405). On the other hand, when the current time has passed the effective period (step S404: No), the personal-information managing apparatus 10 ends the processing without changing the effective period.

While an example in which the effective period can be changed has been explained with reference to the flowchart shown in FIG. 6, the personal-information managing apparatus 10 can be also configured not to permit a change of the effective period. While the effective period is permitted to be changed during only the effective period of the QR code with reference to FIG. 6, it can be arranged such that only a reduction of an initially set effective period is permitted without permitting extension of the effective period. With this arrangement, it is possible to avoid repetitive extension of the effective period, which can make the effective period itself meaningless.

As described above, when the personal-information managing apparatus 10 having a minimum configuration shown in FIG. 2 is used, personal information is not transmitted to the personal terminal 30. Therefore, even when the personal terminal 30 is lost, a leakage of the personal information can be prevented. Since the personal terminal 30 is configured to deliver a QR code, indicating personal information, to the destination terminal 20, disclosure of the personal information can be permitted only after the user of the personal terminal 30 confirms the QR code. Therefore, it is possible to prevent an unaware disclosure of the personal information an unknown third person. Further, by providing the effective period to the QR code, it is possible to decrease a possibility of browsing of the personal information by a third person who has illegally obtained the QR code.

In the personal-information managing apparatus 10 having a minimum configuration shown in FIG. 2, it is assumed that a legitimate person operates the destination terminal 20 or the personal terminal 30. However, when a malicious third person operates the destination terminal 20 or the personal terminal 30, a leakage of personal information is permitted. The personal-information managing apparatus 10 that additionally includes an authentication function of the destination terminal 20 or the personal terminal 30 is explained next.

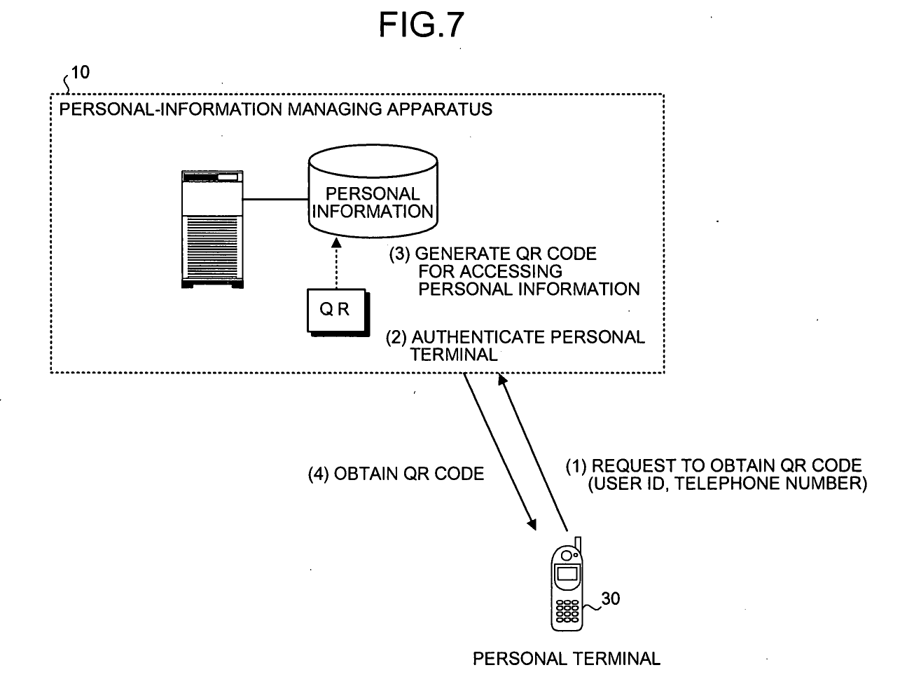

FIG. 7 is a schematic for illustrating an authentication of the personal terminal 30. As shown in FIG. 7, when the personal terminal 30 transmits a QR obtaining request, including a user ID and a telephone number, to the personal-information managing apparatus 10 (see (1) in FIG. 7), the personal-information managing apparatus 10 compares the received user ID and the received telephone number with a user ID and a telephone number that are registered in advance and managed in a “personal information” DB shown in FIG. 7, thereby authenticating the personal terminal 30 (see (2) in FIG. 7). A detailed process of the authentication is described later.

When the personal terminal 30 is authenticated successfully, the personal-information managing apparatus 10 generates a QR code for accessing personal information (see (3) in FIG. 7), and transmits this QR code to the personal terminal 30. Thus, the personal terminal 30 obtains the QR code that indicates personal information (see (4) in FIG. 7).

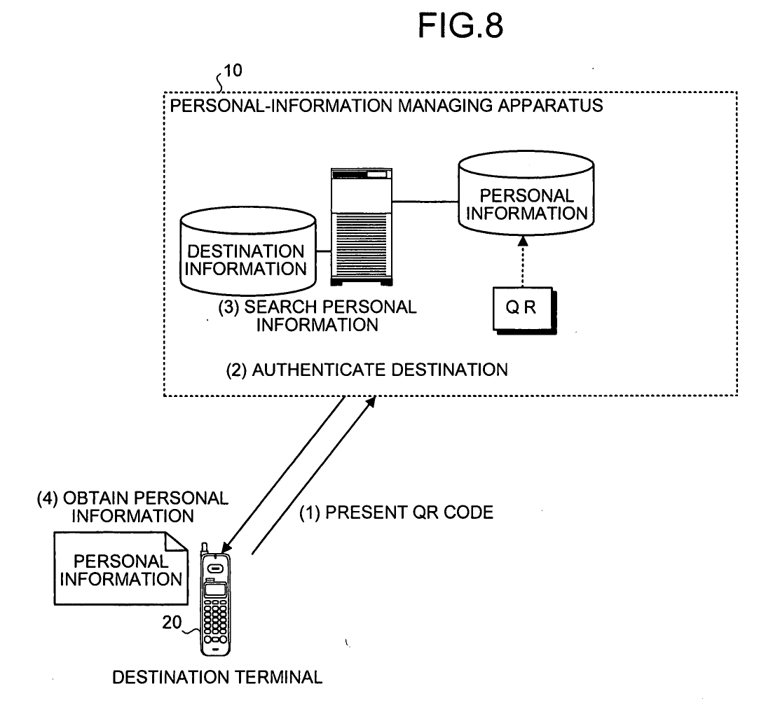

FIG. 8 is a schematic for illustrating an authentication of the destination terminal 20. When the destination terminal 20 presents or transmits the QR code to the personal-information managing apparatus 10 (see (1) in FIG. 8), the personal-information managing apparatus 10 having received the QR code compares a destination terminal ID and an operator ID that are transmitted together with the QR code, with a destination terminal ID and an operator ID that are registered in advance and managed in a “destination information” DB in FIG. 8, thereby authenticating the destination terminal 20 (see (2) in FIG. 8).

When the destination terminal 20 is authenticated successfully, the personal-information managing apparatus 10 searches personal information corresponding to the received QR code (see (3) in FIG. 8), and transmits the extracted personal information to the destination terminal 20. Thus, the destination terminal 20 obtains personal information (see (4) in FIG. 8).

As shown in FIGS. 7 and 8, when the function of authenticating the destination terminal 20 or the personal terminal 30 is added to the personal-information managing apparatus 10, it is possible to prevent a malicious third person from operating the destination terminal 20 or the personal terminal 30. Therefore, a leakage of personal information can be prevented effectively.

FIG. 9 is a block diagram of the personal-information managing apparatus 10 having an authentication function. Differences of the block diagram shown in FIG. 9 from the block diagram shown in FIG. 2 are mainly explained below, and explanation of common points is omitted.

The personal-information managing apparatus 10 added with the authentication function includes a user-authentication processing unit 12e, a destination-authentication processing unit 12f, an encryption processing unit 12g, and a destination-information DB 13c. FIG. 9 depicts management in the personal-information DB 13a of personal authentication information of the user of the personal terminal 30. Alternatively, the personal-information managing apparatus 10 can be also configured to manage the personal authentication information in a DB other than the personal-information DB 13a.

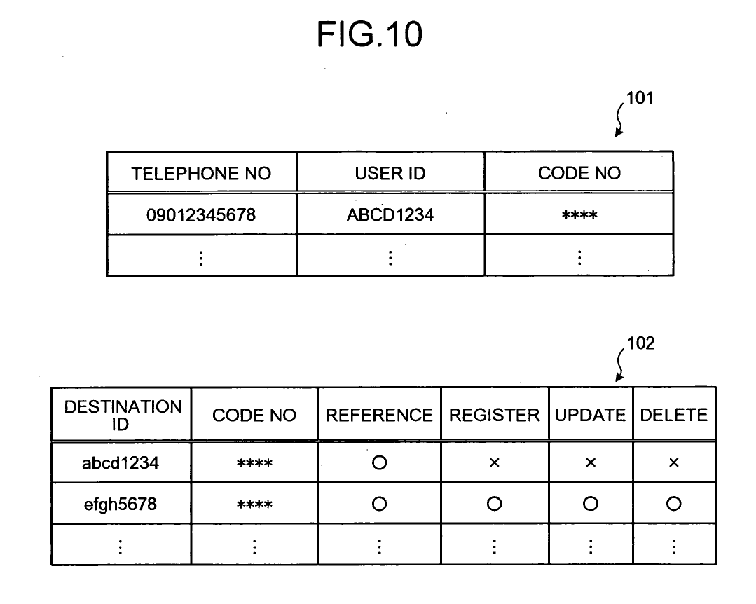

The user-authentication processing unit 12e authenticates the personal terminal 30 that has transmitted a request for obtaining access permission information (QR code). Specifically, the user-authentication processing unit 12e compares information such as a telephone number, a user ID, and a code number that is received from the personal terminal 30, with personal authentication information registered in advance in the personal-information DB 13a, thereby authenticating the personal terminal 30. The personal authentication information is described later with reference to FIG. 10.

The destination-authentication processing unit 12f authenticates the destination terminal 20 that tries to obtain personal information by presenting a QR code. Specifically, the destination-authentication processing unit 12f compares information such as the destination ID and the code number that is received from the destination terminal 20, with the destination authentication information registered in advance in the destination-information DB 13c, thereby authenticating the destination terminal 20.

The encryption processing unit 12g encrypts personal information to be transmitted by the personal-information notifying unit 12d to the destination terminal 20. The encrypted and then transmitted personal information is decrypted by a decryption program that is installed in the legitimate destination terminal 20, to be used. By encrypting the personal information to be transmitted, a leakage of the personal information in a transmission path can be effectively prevented.

The destination-information DB 13c is used to manage the destination authentication information of the destination terminal 20 or the operator of the destination terminal 20.

FIG. 10 is a schematic for illustrating an example of personal authentication information and destination authentication information. A table indicated by a reference numeral 101 shows an example of the personal authentication information, and a table indicated by a reference numeral 102 shows an example of the destination authentication information.

As shown in the table indicated by 101 in FIG. 10, the personal authentication information includes “telephone number”, “user ID”, and “code number”. Biometrics information of a fingerprint and a vein pattern can be also used instead of the code number.

As shown in the table indicated by 102 in FIG. 10, the destination authentication information includes “destination ID”, “code number”, “reference”, “register”, “update”, and “delete”. For example, for a destination with a destination ID of “abcd1234”, only “reference” of the personal information is permitted. For a destination with a destination ID of “efgh5678”, “reference”, “register”, “update”, and “delete” are permitted.

As explained above, by setting an access level to personal information for each destination ID, a presentation level of personal information to the destination can be changed flexibly. Biometrics information of a fingerprint and a vein pattern can be also used instead of the code number, like the personal authentication information.

In the destination authentication information shown in the table indicated by 102 in FIG. 10, an access level to the personal information is set for each destination. Alternatively, it is also possible to set a further detailed access level, that is, an access level for each item of personal information.

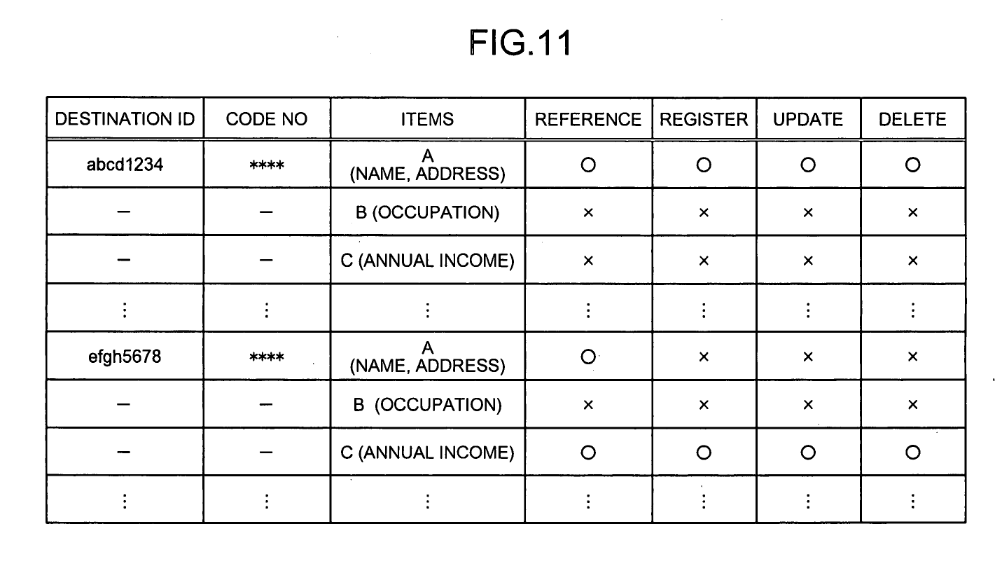

FIG. 11 is a schematic for illustrating an example of the destination authentication information in accordance with personal information items. The destination authentication information includes “destination ID”, “code number”, “item” that expresses personal information, “reference”, “register”, “update”, and “delete”.

For example, for a destination with a destination ID of “abcd1234”, all items from “reference” to “delete” are permitted with respect to item A (name and address). On the other hand, no operation is permitted with respect to item B (occupation) and item C (annual income). By setting an access level to each item of the personal information in this way, a disclosure range of the personal information can be flexibly changed for each destination.

In the above explanation, a portable telephone and a PDA terminal that are commercially available are used as the destination terminal 20. Alternatively, the destination terminal 20 can be configured as a dedicated terminal for browsing personal information. The destination terminal 20 that is configured as a dedicated terminal is explained below.

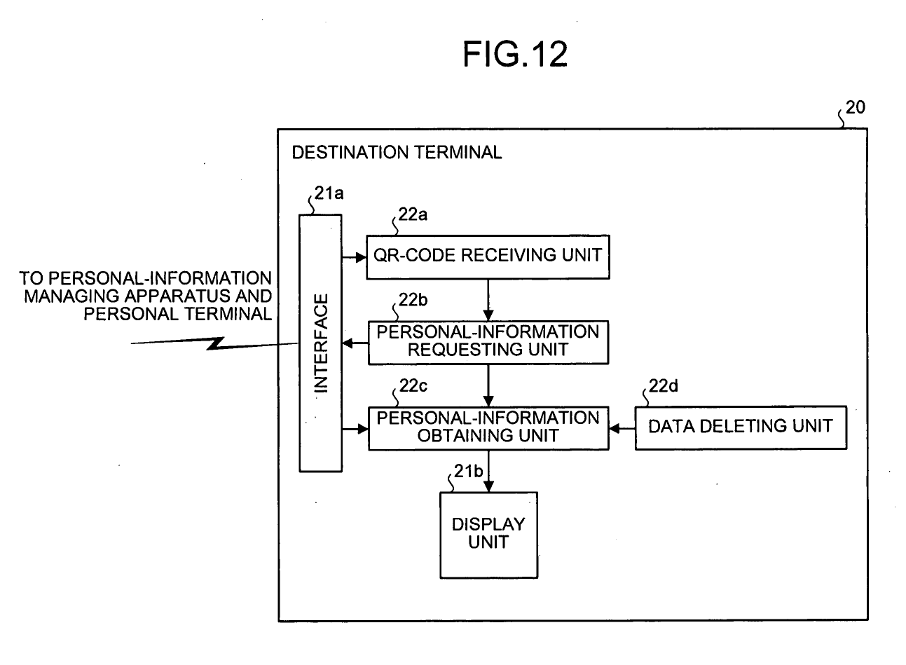

FIG. 12 is a block diagram of the destination terminal 20 according to the present embodiment. The destination terminal 20 includes an interface 21a, a display unit 21b, a QR-code receiving unit 22a, a personal-information requesting unit 22b, a personal-information obtaining unit 22c, and a data deleting unit 22d. In FIG. 12, only key processors among many included in the destination terminal 20 are shown.

The interface 21a can be configured by a communication device that exchanges data between the personal-information managing apparatus 10 and the personal terminal 30. The interface 21a receives a QR code from the personal terminal 30, presents or transmits the QR code to the personal-information managing apparatus 10, and receives personal information. The interface 21a can be also configured by a radio device or a wired device. The display unit 21b is configured by a display unit device such as a liquid crystal display unit. The display unit 21b display units personal information obtained from the personal-information managing apparatus 10.

The QR-code receiving unit 22a is a processor that receives a QR code from the personal terminal 30 via the interface 21a, and delivers the received QR code to the personal-information requesting unit 22b. The personal-information requesting unit 22b transmits the QR code received from the QR-code receiving unit 22a, to the personal-information managing apparatus 10. The personal-information requesting unit 22b transmits the QR code together with the destination ID and the code number shown in the table indicated by 102 in FIG. 10, to the personal-information managing apparatus 10.

The personal-information obtaining unit 22c is a processor that obtains personal information from the personal-information managing apparatus 10 via the interface 21a, and outputs the obtained personal information to the display unit 21b. The data deleting unit 22d is a processor that erases personal information stored in a random access memory (RAM) or the like after the personal information is display united on the display unit 21b. By erasing the personal information after this information is used, it is possible to effectively prevent a leakage of the personal information that remains in the destination terminal 20.

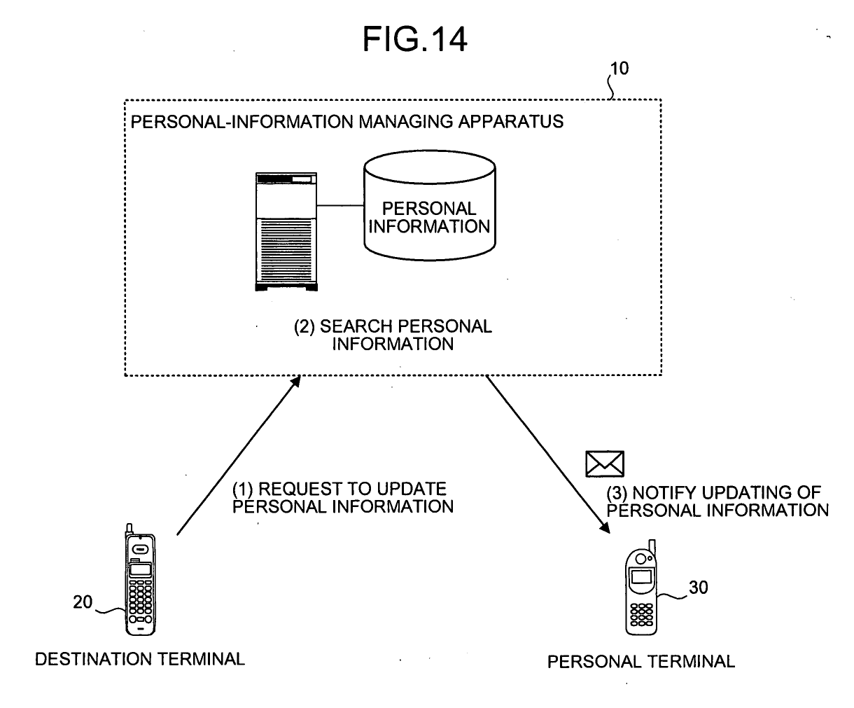

The personal-information managing apparatus 10 can be added with a function of notifying the reference of personal information, a function of updating personal information, and a function of notifying the update of the personal information. The personal-information managing apparatus 10 added with the function of updating personal information and the function of notifying the update of the personal information is explained below with reference to FIG. 14.

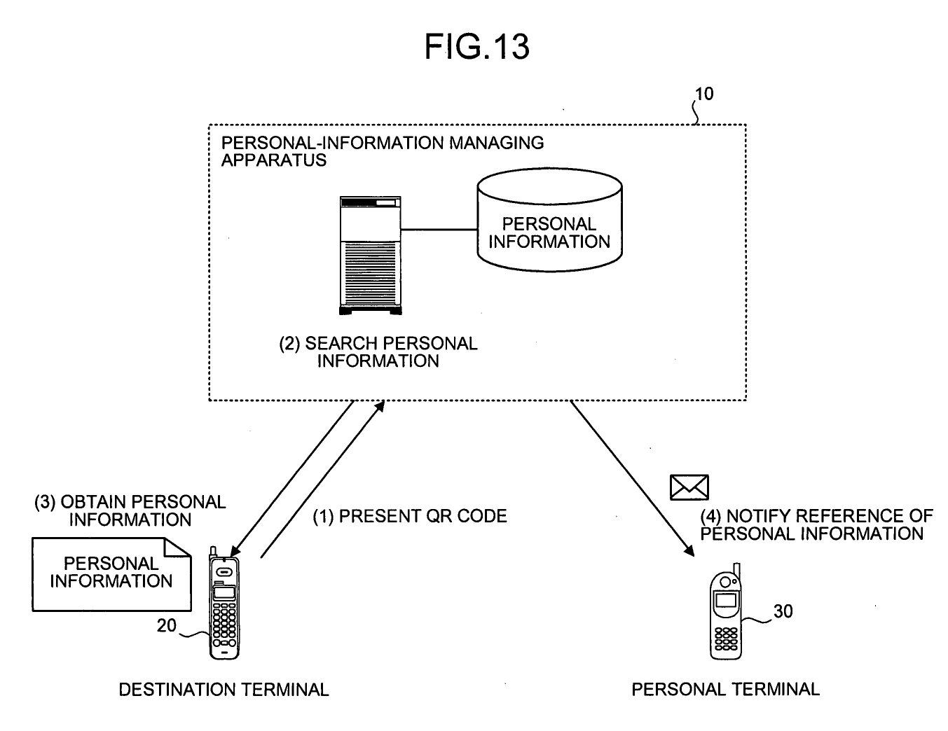

FIG. 13 is a schematic for illustrating a personal-information-reference notifying process. When the destination terminal 20 presents a QR code to the personal-information managing apparatus 10 (see (1) in FIG. 13), the personal-information managing apparatus 10 searches personal information corresponding to the QR code (see (2) in FIG. 13), and transmits the obtained personal information to the destination terminal 20. Thus, the destination terminal 20 obtains the personal information (see (3) in FIG. 13).

The personal-information managing apparatus 10 transmits a personal information reference notice, indicating that the personal information is disclosed to the destination terminal 20, to the personal terminal 30 (see (4) in FIG. 13). As explained above, when the fact that the personal information is referenced is notified to the personal terminal 30, the personal terminal 30 can confirm the reference state of the personal information, and can quickly know a leakage of the personal information attributable to an illegitimate practice.

An e-mail, a short message, a telephone, a facsimile, and the like can be used as means for notifying the reference of the personal information in (4) in FIG. 13.

FIG. 14 is a schematic for illustrating a personal-information updating process and a personal-information-update notifying process. When the destination terminal 20 transmits a personal information updating request to the personal-information managing apparatus 10 (see (1) in FIG. 14), the personal-information managing apparatus 10 updates the personal information subject to a condition that the destination terminal 20 has passed the authentication process (see (2) in FIG. 14), and transmits a personal information update notice, indicating that the personal information is updated, to the personal terminal 30 (see (3) in FIG. 14).

As explained above, if the personal information can be updated, information such as a violation record of a driver's license and a test record at a hospital regarding an insurance card can always be kept up to date.

By notifying the personal terminal 30 that the personal information has been updated, the personal terminal 30 can confirm the updated state of the personal information, and can quickly know tampering and the like of the personal information. Email, short message, telephone, facsimile, and the like can be used as means for notifying the updating of the personal information in (3) in FIG. 14.

FIG. 15 is a block diagram of the personal-information managing apparatus 10 having a personal-information updating function and a personal-information notifying function. Differences of the block diagram shown in FIG. 15 from the block diagram shown in FIG. 9 are mainly explained below, and an explanation of common points is omitted.

The personal-information managing apparatus 10 added with the personal information updating and notification functions has a personal-information-reference-and-update notifying unit 12h and a personal-information updating unit 12i. The personal-information-reference-and-update notifying unit 12h monitors the access state of the personal-information DB 13a, and notifies a reference or updating of the personal information, if any, to the personal terminal 30.

The personal-information updating unit 12i receives a request for updating personal information subject to a condition that the “update” item of the destination authentication information shown in the table of 102 in FIG. 10 or FIG. 11 is permitted, regarding the destination terminal 20 that is successful in authenticating the destination-authentication processing unit 12f. The personal-information updating unit 12i updates the personal-information DB 13a based on the received request for updating the personal information.

The personal-information managing apparatus 10 can also additionally have a charge function. When the personal-information managing apparatus 10 additionally has the charge function, the personal-information managing apparatus 10 can charge according to the provision of personal information. Further, the personal-information managing apparatus 10 can charge the user of the personal terminal 30 a penalty for violating the driver's license and medical service fee regarding an insurance card. The personal-information managing apparatus 10 added with the charge function is explained next.

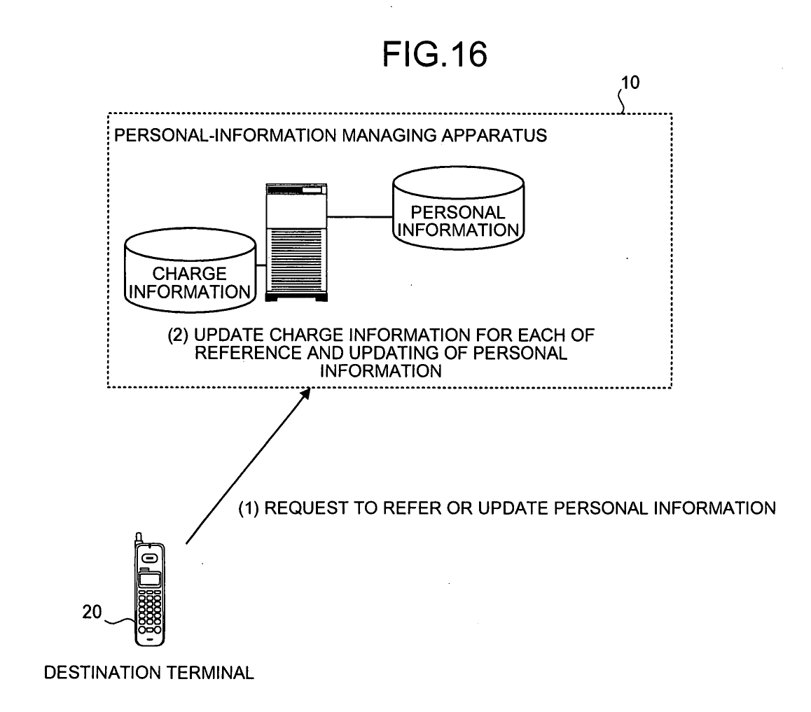

FIG. 16 is a schematic for illustrating a charging process. When the destination terminal 20 transmits a request for referencing personal information or a request for updating the personal information to the personal-information managing apparatus 10 (see (1) in FIG. 16), the personal-information managing apparatus 10 having received this request updates charge information for each reference and update of the personal information (see (2) in FIG. 16). The personal-information managing apparatus 10 charges the user of the personal terminal 30 based on the charge information.

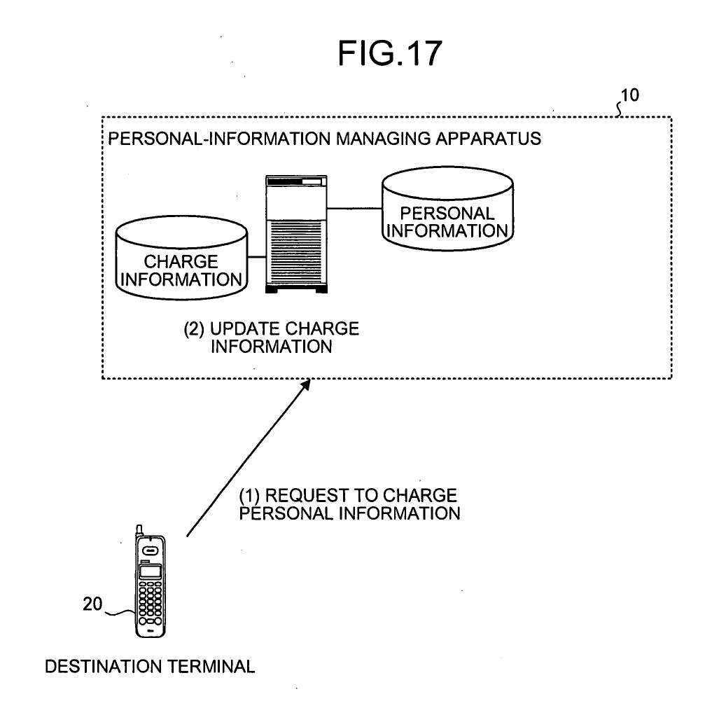

FIG. 17 is a schematic for illustrating a charge-information updating process. When the destination terminal 20 transmits a request for updating the charge information to the personal-information managing apparatus 10 (see (1) in FIG. 17), the personal-information managing apparatus 10 having received this request updates the charge information (see (2) in FIG. 17). The charge-information updating process shown in FIG. 17 corresponds to a charge of penalty for a traffic violation.

FIG. 18 is a block diagram of the personal-information managing apparatus 10 having a record function and a charge function. Differences of the block diagram shown in FIG. 18 from the block diagram shown in FIG. 15 are mainly explained below, and explanation of common points is omitted.

The personal-information managing apparatus 10 added with the record function and the charge function further includes a charging processing unit 12j, a disclosure-record DB 13d, and a charge-information DB 13e. The charging processing unit 12j charges the user of the personal terminal 30 based on charge information stored in the charge-information DB 13e. In this embodiment, the personal terminal 30 is charged. Alternatively, it is also possible to charge the destination terminal 20 or charge the destination terminal 20 and the personal terminal 30 at a predetermined rate.

Each time when the personal-information notifying unit 12d provides personal information to the destination terminal 20, the disclosure-record DB 13d stores a disclosure record (for example, a disclosure content, a type of access such as updating and deleting, and date and time). By storing the disclosure record, a leakage route of personal information, if any, can be found out easily, thereby effectively preventing a secondary leakage of information.

The charge-information DB 13e calculates charge amount based on an issuance state (including a change of the effective period) of access permission information (QR code) stored in the access-permission-information DB 13b, and a disclosure record of personal information stored in the disclosure-record DB 13d. The charge-information DB 13e stores charge information with the calculated amount related to a charge destination.

As explained above, according to the present embodiment, the access permission information for accessing personal information of a specific user is issued in response to a request from the personal terminal used by the user. The destination terminal having received the access permission information from the personal terminal notifies the destination terminal about the personal information corresponding to the access permission information subject to a condition that the access permission information has been presented. With this arrangement, even when the personal terminal is lost, the personal information is not leaked out. To provide the personal information, the user needs to confirm this provision of the personal information. Therefore, it is possible prevent transmission of the personal information to a third person while the user is not aware of this transmission.

According to the present invention, it is possible to increase convenience of confirming the user while preventing a leakage of the personal information.

Furthermore, according to the present invention, tampering of the personal information can be prevented effectively.

Moreover, according to the present invention, the access permission information can be delivered easily from the personal terminal to the destination terminal.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A personal-information managing apparatus comprising:
an access-permission-information issuing unit that issues access permission information for accessing personal information on a user, in response to a request from a personal terminal of the user; and
a personal-information notifying unit that notifies a destination terminal of the personal information corresponding to the access permission information, under conditions that the destination terminal that received the access permission information from the personal terminal presents the access permission information.

2. The personal-information managing apparatus according to claim 1, wherein
the access-permission-information issuing unit copies the personal information into a temporary storage area, and issues access permission information for accessing the temporary storage area to the personal terminal.

3. The personal-information managing apparatus according to claim 1, wherein
the access-permission-information issuing unit and the personal-information notifying unit use a uniform resource locator or a quick-response code for accessing the personal information as the access permission information.

4. The personal-information managing apparatus according to claim 1, further comprising:
a personal-terminal authenticating unit that authenticates that the personal terminal is operated by a legitimate user, wherein
the access-permission-information issuing unit issues the access permission information to the personal terminal under conditions that the personal-terminal authenticating unit successfully authenticated that the personal terminal is operated by the legitimate user.

5. The personal-information managing apparatus according to claim 1, further comprising:
a destination-terminal authenticating unit that authenticates that the destination terminal is a legitimate terminal, wherein
the personal-information notifying unit notifies the destination terminal of the personal information under conditions that the destination-terminal authenticating unit successfully authenticated that the destination terminal is the legitimate terminal.

6. The personal-information managing apparatus according to claim 1, wherein
the personal-information notifying unit encrypts the personal information before notifying the destination terminal of the personal information.

7. The personal-information managing apparatus according to claim 1, further comprising:
a destination managing unit that manages a disclosure destination of the personal information for every personal information, wherein
the personal-information notifying unit notifies the destination terminal of the personal information under conditions that an identifier of a user of the destination terminal corresponds to the disclosure destination.

8. The personal-information managing apparatus according to claim 7, wherein
the destination managing unit manages the disclosure destination for every item contained in the personal information, and
the personal-information notifying unit notifies the item under conditions that the identifier of the user of the destination terminal corresponds to the disclosure destination.

9. The personal-information managing apparatus according to claim 1, further comprising:
a charging unit that charges the user under conditions that the personal-information notifying unit notified the personal information to the destination terminal that presented the access permission information in units of the access permission information.

10. The personal-information managing apparatus according to claim 1, wherein
the access-permission-information issuing unit sets an effective period of the access permission information before issuing the access permission information, and
the personal-information notifying unit notifies the destination terminal of the personal information under condition that the effective period of the access permission information presented by the destination terminal is valid.

11. The personal-information managing apparatus according to claim 1, further comprising:
an effective-period managing unit that manages the effective period for every piece of the access permission information issued by the access-permission-information issuing unit, wherein
the personal-information notifying unit notifies the destination terminal of the personal information when the access permission information presented by the destination terminal is within the effective period obtained from the effective-period managing unit.

12. The personal-information managing apparatus according to claim 11, wherein
the effective-period managing unit permits an extension of the effective period that is once set, within the effective period.

13. The personal-information managing apparatus according to claim 11, wherein
the effective-period managing unit does not permit an extension of the effective period that is once set.

14. The personal-information managing apparatus according to claim 9, further comprising:
a personal-information updating unit that updates the personal information based on an instruction from the destination terminal.

15. A computer-readable recording medium that stores therein a computer program for a personal-information managing apparatus that manages electronic personal information, wherein
the computer program causes a computer to execute:
issuing access permission information for accessing personal information on a user, in response to a request from a personal terminal of the user; and
notifying a destination terminal of the personal information corresponding to the access permission information, under conditions that the destination terminal that received the access permission information from the personal terminal presents the access permission information.

16. A personal-information-providing system comprising:
a personal-information managing apparatus that manages electronic personal information;
a personal terminal that is used by a user; and
a destination terminal that is a disclosure destination of the personal information, wherein
the personal-information managing apparatus includes
an access-permission-information issuing unit that issues access permission information for accessing personal information on a user, in response to a request from a personal terminal of the user; and
a personal-information notifying unit that notifies a destination terminal of the personal information corresponding to the access permission information, under conditions that the destination terminal that received the access permission information from the personal terminal presents the access permission information,
the personal terminal includes an access-permission-information delivering unit that delivers the access permission information issued by the personal-information managing apparatus to the destination terminal, and
the destination terminal includes an access-permission-information presenting unit that presents the access permission information delivered from the personal terminal to the personal-information managing apparatus.

17. The personal-information-providing system according to claim 16, wherein
the destination terminal is a dedicated terminal manufactured as a reference terminal for the personal information.

18. The personal-information-providing system according to claim 16, wherein
the destination terminal is a commercially available terminal with a program including a function of referring to the personal information.

19. The personal-information-providing system according to claim 16, wherein
the destination terminal further includes a personal-information deleting unit that deletes the personal information from the destination terminal after displaying the personal information.
